(19) United States
(12) Patent Application Publication
(10) Pub. No.: US 2016/0269690 A1
(43) Pub. Date: Sep. 15, 2016

(54) Train Safety Assembly

(71) Applicant: Aaron Mitchell, Birmingham, AL (US)

(72) Inventor: Aaron Mitchell, Birmingham, AL (US)

(21) Appl. No.: 14/657,496

(22) Filed: Mar. 13, 2015

(51) Int. Cl. H04N 7/18; B60R 11/00; B60T 17/22; B60R 1/00; B61K 13/00; H04N 5/225

(52) U.S. Cl. CPC H04N 7/183; B61K 13/00; H04N 5/2251; B60T 17/228; B60R 1/002; B60R 11/00; B60R 2011/004

(57) ABSTRACT

A train safety assembly for monitoring activity behind a rearmost train car includes a remote unit that may be coupled to a rear side of the rearmost train car. The remote unit monitors activity behind the rearmost train car. A base unit may be positioned within a train engine and the base unit is in communication with the remote unit. The base unit displays the activity behind the rearmost train car.

### BACKGROUND OF THE DISCLOSURE

### Field of the Disclosure

The disclosure relates to safety devices and more particularly pertains to a new safety device for monitoring activity behind a rearmost train car.

### SUMMARY OF THE DISCLOSURE

An embodiment of the disclosure meets the needs presented above by generally comprising a remote unit that may be coupled to a rear side of a rearmost train car. The remote unit monitors activity behind the rearmost train car. A base unit may be positioned within a train engine and the base unit is in communication with the remote unit. The base unit displays the activity behind the rearmost train car.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a train safety assembly according to an embodiment of the disclosure.

FIG. 2 is a right side view of an embodiment of the disclosure.

FIG. 3 is a top perspective view of an embodiment of the disclosure.

FIG. 4 is a perspective view of an embodiment of the disclosure.

FIG. 5 is a schematic view of an embodiment of the disclosure.

### DESCRIPTION OF THE PREFERRED EMBODIMENT

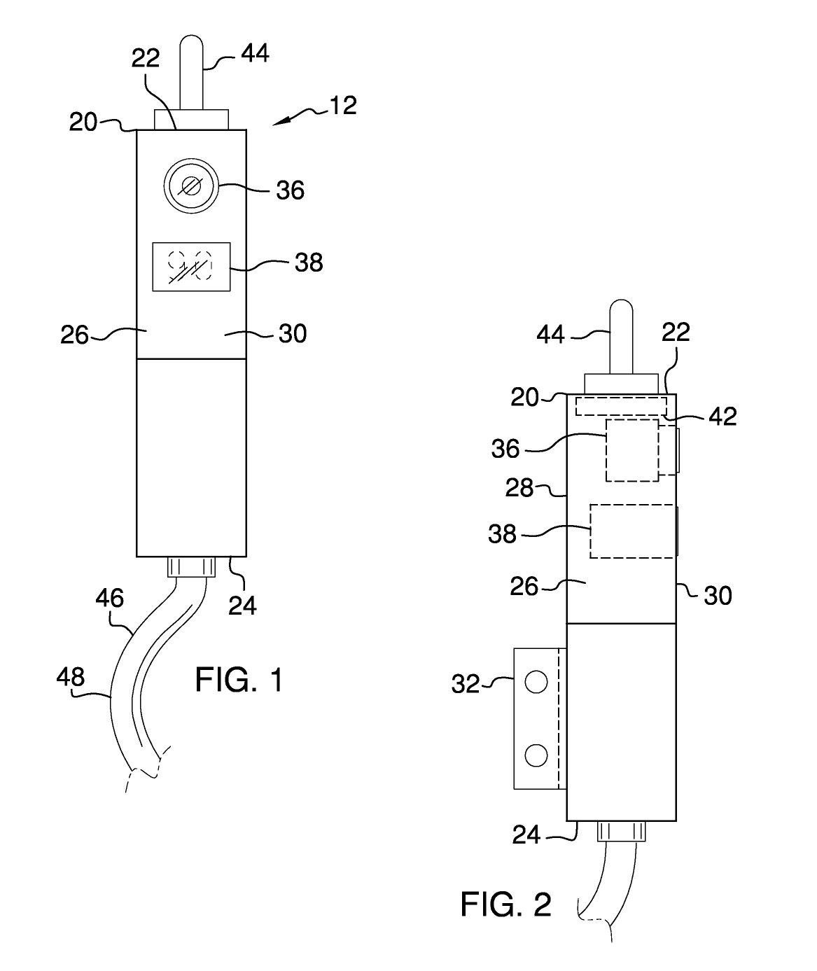

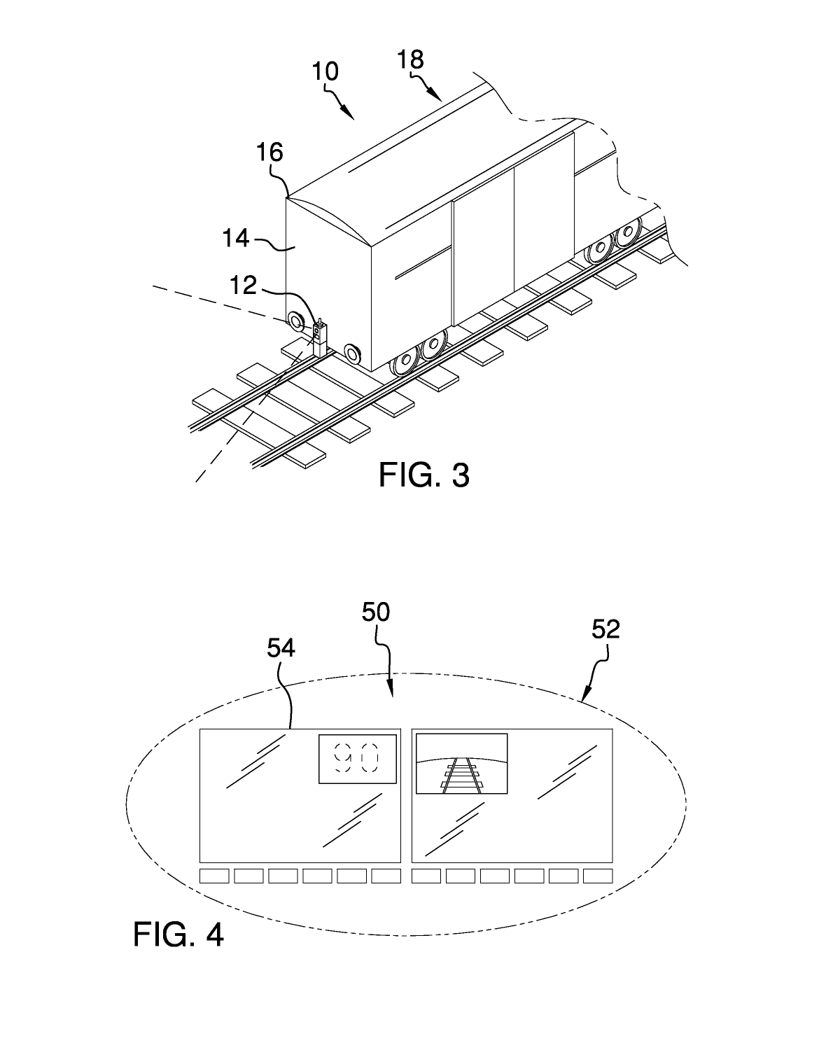

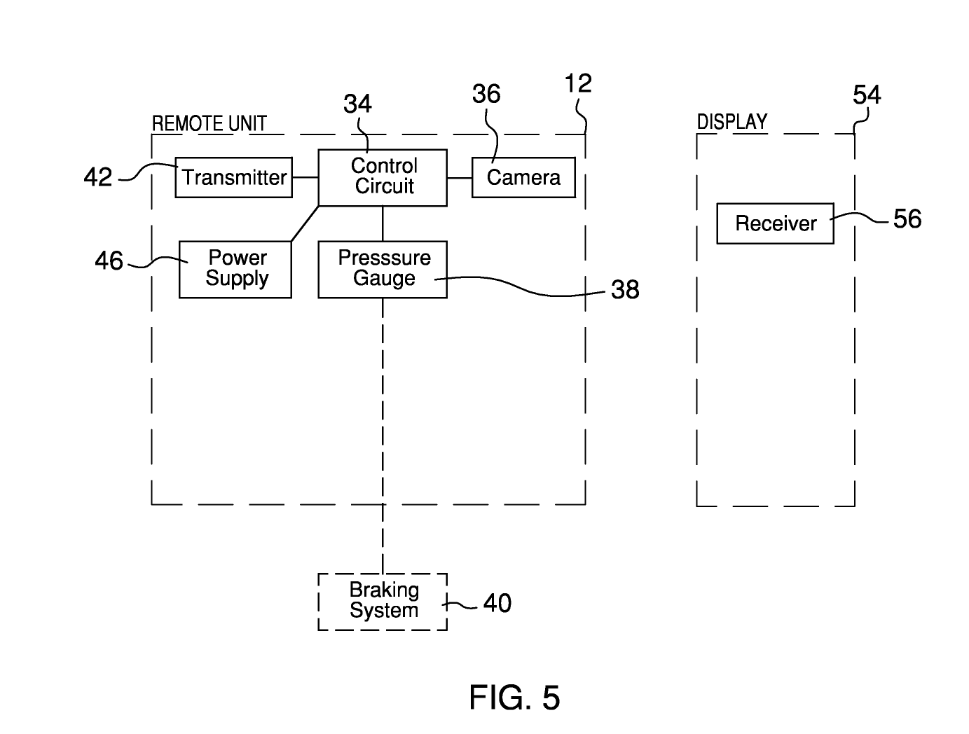

With reference now to the drawings, and in particular to FIGS. 1 through 5 thereof, a new safety device embodying the principles and concepts of an embodiment of the disclosure and generally designated by the reference numeral 10 will be described.

As best illustrated in FIGS. 1 through 5, the train safety assembly 10 generally comprises a remote unit 12 that may be coupled to a rear side 14 of a rearmost train car 16. The rearmost train car 16 may be a caboose or other train car coupled to a train 18. The remote unit 12 monitors activity behind the rearmost train car 16 while the train 18 is in motion. The remote unit 12 comprises a housing 20 that has a top wall 22, a bottom wall 24 and a peripheral wall 26 extending between the top wall 22 and the bottom wall 24. The peripheral wall 26 has a back side 28 and a front side 30 and a bracket 32 is attached to the back side 28. The bracket 32 may be attached to the rear side 14 of the rearmost train car 16 having the front side 30 facing away from the rear side 14 of the rearmost train car 16.

A control circuit 34 is positioned within the housing 20 and a camera 36 is coupled to the front side 30 of the housing 20. The camera 36 is electrically coupled to the control circuit 34 and the camera 36 records the activity behind the rearmost train car 16. The camera 36 may be a digital video camera or the like. A pressure gauge 38 is attached to the front side 30 and the pressure gauge 38 is electrically coupled to the control circuit 34. The pressure gauge 38 is in communication with a braking system 40 of the rearmost train car 16 to display an operational pressure of the braking system 40. The pressure gauge 38 may be a digital gauge or the like.

A transmitter 42 is positioned within the housing 20 and the transmitter 42 is electrically coupled to the control circuit 34. The transmitter 42 includes an antenna 44 coupled to the top wall 22 and the transmitter 42 transmits the activity recorded by the camera 36. The transmitter 42 may be a radio frequency transmitter or the like. A power supply 46 is attached to the housing 20 and the power supply 46 is electrically coupled to the control circuit 34. The power supply 46 is electrically coupled to the rearmost train car 16 to supply electrical power to the remote unit 12. The power supply 46 comprises a cord 48 extending outwardly from the bottom wall 24 of the housing 20.

A base unit 50 is provided that may be positioned within a train engine 52. The base unit 50 is in communication with the remote unit 12 and the base unit 50 displays the activity behind the rearmost train car 16. The base unit 50 comprises a display 54 positioned within the train engine 52. The display 54 may be an LCD display or the like.

A receiver 56 is positioned within the display 54 and the receiver 56 is in electrical communication with the transmitter 42. The receiver 56 receives the activity recorded by the camera 36. The display 54 displays the activity recorded by the camera 36 and the operational pressure detected by the pressure gauge 38. The receiver 56 may be a radio frequency receiver or the like.

In use, the display 54 is observed in order to observe the activity behind the rearmost train car 16. The camera 36 allows the train 18 to potentially avoid crashing into an object or a person while the train 18 is backing up thereby reducing the possibility of personal injury, death or property damage. Additionally, the display 54 is observed to know when the rearmost train car 16 has fully crossed a roadway or other crossing area of a railroad thereby facilitating the roadway or crossing area to remain clear.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A train safety assembly configured to monitor activity behind a train, said assembly comprising:
a remote unit configured to be coupled to a rear side of a rearmost train car, said remote unit being configured to monitor activity behind the rearmost train car; and
a base unit configured to be positioned within a train engine, said base unit being in communication with said remote unit, said base unit displaying the activity behind the rearmost train car.

2. The assembly according to claim 1, wherein said remote unit comprises a housing having a top wall, a bottom wall and a peripheral wall extending between said top wall and said bottom wall, said peripheral wall having a back side and a front side.

3. The assembly according to claim 2, further comprising a bracket attached to said back side, said bracket being configured to be attached to the rear side of the rearmost train car, said front side being configured to face away from the rear side of the rearmost train car.

4. The assembly according to claim 3, further comprising a control circuit positioned within said housing, a camera coupled to said front side of said housing, said camera being electrically coupled to said control circuit, said camera being configured to record the activity behind the rearmost train car.

5. The assembly according to claim 4, further comprising a pressure gauge attached to said front side, said pressure gauge being electrically coupled to said control circuit, said pressure gauge being configured to be in communication with a braking system of the rearmost train car, said pressure gauge being configured to display an operational pressure of the braking system.

6. The assembly according to claim 5, further comprising a transmitter positioned within said housing, said transmitter being electrically coupled to said control circuit wherein said transmitter transmits the activity recorded by said camera, said transmitter including an antenna coupled to said top wall.

7. The assembly according to claim 6, further comprising a power supply attached to said housing, said power supply being electrically coupled to said control circuit, said power supply being configured to be electrically coupled to the rearmost train car.

8. The assembly according to claim 1, wherein said base unit comprises a display configured to be positioned within the train engine.

9. The assembly according to claim 8, further comprising:
a transmitter;
a camera;
a pressure gauge; and
a receiver positioned within said display, said receiver being in electrical communication with said transmitter wherein said receiver receives the activity recorded by said camera, said display displaying the activity recorded by said camera and the operational pressure detected by said pressure gauge.

10. A train safety assembly configured to monitor activity behind a train, said assembly comprising:
a remote unit configured to be coupled to a rear side of a rearmost train car, said remote unit being configured to monitor activity behind the rearmost train car, said remote unit comprising
a housing having a top wall, a bottom wall and a peripheral wall extending between said top wall and said bottom wall, said peripheral wall having a back side and a front side,
a bracket attached to said back side, said bracket being configured to be attached to the rear side of the rearmost train car, said front side being configured to face away from the rear side of the rearmost train car,
a control circuit positioned within said housing,
a camera coupled to said front side of said housing, said camera being electrically coupled to said control circuit, said camera being configured to record the activity behind the rearmost train car,
a pressure gauge attached to said front side, said pressure gauge being electrically coupled to said control circuit, said pressure gauge being configured to be in communication with a braking system of the rearmost train car, said pressure gauge being configured to display an operational pressure of the braking system,
a transmitter positioned within said housing, said transmitter being electrically coupled to said control circuit wherein said transmitter transmits the activity recorded by said camera, said transmitter including an antenna coupled to said top wall, and
a power supply attached to said housing, said power supply being electrically coupled to said control circuit, said power supply being configured to be electrically coupled to the rearmost train car, and
a base unit configured to be positioned within a train engine, said base unit being in communication with said remote unit, said base unit displaying the activity behind the rearmost train car, said base unit comprising a display configured to be positioned within the train engine, and
a receiver positioned within said display, said receiver being in electrical communication with said transmitter wherein said receiver receives the activity recorded by said camera, said display displaying the activity recorded by said camera and the operational pressure detected by said pressure gauge.
